(19) United States
(12) Patent Application Publication
(10) Pub. No.: US 2024/0286611 A1
(43) Pub. Date: Aug. 29, 2024

(54) Method and Device for Controlling the Transition Between Different Driving Functions

(71) Applicant: Bayerische Motoren Werke Aktiengesellschaft, Muenchen (DE)

(72) Inventors: Christian SCHWALBACH, Muenchen (DE); Tamas FENDLER, Eching (DE)

(21) Appl. No.: 18/572,236

(22) PCT Filed: Jun. 20, 2022
(86) PCT No.: PCT/EP2022/066708

§ 371 Date: Dec. 20, 2023

(30) Foreign Application Priority Data
Jun. 24, 2021 (DE) 10 2021 116 338.2

(51) Int. Cl. B60W 30/14; B60W 30/16; B60W 50/08

(52) U.S. Cl. CPC B60W 30/143; B60W 30/146; B60W 30/16; B60W 50/082; B60W 2520/10; B60W 2552/30; B60W 2720/10; B60W 2754/30

(57) ABSTRACT

An apparatus for controlling a change between different driving functions for the at least partially automated longitudinal guidance of a vehicle is provided. The apparatus is designed to detect that it is intended to change from a first driving function to a different second driving function. The apparatus is also designed to automatically adopt a set speed from the first driving function for the second driving function for the at least partially automated longitudinal guidance.

### BACKGROUND AND SUMMARY

The invention relates to a method and a corresponding device for controlling the transition between different driving functions for the automated longitudinal guidance of a vehicle.

A vehicle may have different driving functions which support the driver of the vehicle in the longitudinal guidance of the vehicle. An exemplary driving function is a distance and speed controller (in particular adaptive cruise control, ACC), where the driving speed of the vehicle is set automatically depending on the distance between the vehicle and a leading vehicle driving directly in front of the vehicle and/or depending on a set speed which is stipulated by the driver. A further exemplary driving function is a speed controller, where the driving speed of the vehicle is set, in particular controlled, in accordance with the set speed. A further exemplary driving function is a distance and speed controller combined with a lateral guidance controller, for example, in order to keep the vehicle in the lane in which it is currently traveling. A further exemplary driving function is a speed limiter for limiting the driving speed to the set speed which is stipulated by the driver or to a speed limit which is identified by the vehicle. A speed limit which is identified by the vehicle may in this case be adopted manually or automatically as the set speed for the speed limiter.

The driver of the vehicle can select at least one driving function from a list of different driving functions depending on the driving situation. This may result in a change between different driving functions while the vehicle is driving. The present document deals with the technical problem of safely increasing the comfort of the driver of the vehicle when changing between driving functions.

The object is achieved by each of the independent claims. Advantageous embodiments are described, inter alia, in the dependent claims. It is pointed out that additional features of a patent claim dependent on an independent patent claim may form, without the features of the independent patent claim or only in combination with a subset of the features of the independent patent claim, a separate invention which is independent of the combination of all features of the independent patent claim and can be made into the subject matter of an independent claim, a divisional application or a subsequent application. This applies in the same manner to technical teachings which are described in the description and may form an invention which is independent of the features of the independent patent claims.

One aspect describes a device for controlling a change between different driving functions for the at least partially automated longitudinal guidance of a vehicle. The different driving functions may in this case differ in relation to how the respective driving function acts on the longitudinal guidance (and where appropriate the lateral guidance) of the vehicle. By way of example, a driving function can be designed to limit the driving speed of the vehicle. Furthermore, another driving function can be designed to control the driving speed of the vehicle in accordance with a determined target specification. In this case, in order to set or limit the driving speed, it is possible to use a set speed which can be stipulated, for example, manually by the driver of the vehicle and/or which can be adopted automatically by the respective driving function (e.g., on the basis of an identified speed limit in the lane on which the vehicle is traveling).

Depending on the driving function, it is thus possible to use the set speed as a target specification for a speed controller for setting the driving speed of the vehicle or as a limit for the driving speed of the vehicle.

A change between two driving functions can typically be made between driving functions from a determined set of possible driving functions. The set of possible driving functions may include:
a distance and speed controller which is designed, in particular, to set the driving speed of the vehicle in such a way that the vehicle is at a defined set distance from a leading vehicle and, if there is no leading vehicle present, that the vehicle is at the set speed;
a pure speed controller which is designed, in particular, to control the driving speed with the set speed as a target specification (without taking into account the distance from a leading vehicle in the process);
a speed limiter which is designed, in particular, to ensure that the driving speed of the vehicle (which is set, for example, manually by the driver) does not exceed the set speed;
a distance and speed controller with combined lateral guidance which is designed, in particular, in addition to the aforementioned longitudinal guidance, to also bring about automated lateral guidance (e.g., in order to keep the vehicle in the current lane);
a driving function for identifying and for automatically or manually adopting a speed limit which is configured, in particular, to ascertain the set speed in order to limit the driving speed of the vehicle on the basis of a present speed limit in the lane in which the vehicle is traveling and to use the set speed in the aforementioned speed limiter; in this case, the identified speed limit may be adopted automatically as the set speed or only after manual confirmation by the driver of the vehicle; and/or
a driving function for taking into account an upcoming route incident, in particular a bend or a signaling installation, in the longitudinal guidance of the vehicle, wherein the driving function is configured, in particular, to bring about automatic deceleration of the vehicle ahead of a route incident.

The device is configured to detect that there is an intention to change from a first driving function to a different second driving function (e.g., in each case from the aforementioned set of possible driving functions). The vehicle typically comprises a user interface. The device may be configured to detect the change from the first driving function to the second driving function on the basis of a user input via the user interface. In this case, the user interface may be designed to make it possible for a user (in particular the driver) of the vehicle to scroll through the list of possible driving functions by actuating an operating element (e.g., a rocker switch) in order to effect the user input for the change from the first driving function to the second driving function. It is thus possible to change to a different second driving function and for this to be identified by the device in a particularly convenient and reliable manner.

The device is also configured to automatically adopt the set speed for the at least partially automated longitudinal guidance from the first driving function for the second driving function. Automatically adopting the set speed makes it possible to achieve a particularly comfortable transition between different driving functions.

The device may be configured to check whether the change from the first driving function to the second driving function is an exceptional change from a (predefined) set of one or more exceptional changes where the set speed is not intended to be adopted automatically for the second driving function. The set of exceptional changes may include, in particular, a change (from any first driving function) to a speed limiter as second driving function and/or a change (from any first driving function) to a pure speed controller as second driving function (in particular when, at the time of the change, the current driving speed of the vehicle is higher than the set speed of the first driving function). The set of exceptional changes may be stored in a memory unit of the vehicle.

The device may also be configured to prevent the set speed from being adopted automatically when it is determined that the change from the first driving function to the second driving function is an exceptional change (from the set of exceptional changes). As an alternative or in addition, the device may be configured to automatically adopt the set speed, in particular only when it is determined that the change from the first driving function to the second driving function is not an exceptional change (from the set of exceptional changes).

By taking into account one or more exceptional changes for which the set speed is not automatically adopted, it is possible to further increase driving safety and comfort.

The device may be configured to ascertain whether the current driving speed of the vehicle (when performing the change from the first driving function to the second driving function) is higher or lower than the set speed. The change from the first driving function to the second driving function may, where appropriate, be considered an exceptional change, in particular only when it is ascertained that the current driving speed is higher or lower than the set driving speed. As an alternative or in addition, it is possible to prevent the set speed from being adopted automatically, in particular only when it is ascertained that the current driving speed is higher or lower than the set speed. By taking into account the current driving speed of the vehicle upon the change between the two driving functions, it is possible to increase comfort further.

By way of example, it is possible to ascertain that the second driving function is a speed limiter. In this case, the change from the first driving function to the second driving function (that is to say the speed limiter) may be considered an exceptional change, in particular only when it is ascertained that the current driving speed is higher than the set speed. As an alternative or in addition, it is possible to prevent the set speed from being adopted automatically, in particular only when it is ascertained that the current driving speed is higher than the set speed. The device may thus be configured to ensure that no value which is lower than the current driving speed is adopted as the set speed for the speed limiter (as second driving function).

In another example, it is possible to ascertain that the second driving function is a pure speed controller (without distance control). In this case, the change from the first driving function to the second driving function (that is to say the pure speed controller) may be considered an exceptional change, in particular only when it is ascertained that the current driving speed is lower than the set speed. As an alternative or in addition, it is possible to prevent the set speed from being adopted automatically, in particular only when it is ascertained that the current driving speed is lower than the set speed. The device may thus be configured to ensure that no value which is higher than the current driving speed is adopted as the set speed for the pure speed controller (as second driving function).

In another example, the second driving function may be a distance and speed controller. In this case, the set speed may where appropriate always be adopted automatically by the first driving function (irrespective of the current driving speed of the vehicle).

The device may be configured to use the current driving speed of the vehicle (at the time of the change between the driving functions) as the set speed for the second driving function when it is determined that the change from the first driving function to the second driving function is an exceptional change and/or when it is determined that the set speed is not adopted automatically. Comfort can thus be increased further.

Another aspect describes a (road) motor vehicle (in particular an automobile or a truck or a bus or a motorcycle) which comprises the device described in this document.

Another aspect describes a method for controlling a change between different driving functions for the at least partially automated longitudinal guidance of a vehicle. The method comprises detecting that there is an intention to change from a first driving function to a different second driving function. The method furthermore comprises automatically adopting the set speed for the at least partially automated longitudinal guidance from the first driving function for the second driving function.

Another aspect describes a software (SW) program. The SW program may be configured to be executed on a processor (for example on a control unit of a vehicle) and to thereby carry out the method described in this document.

A further aspect describes a storage medium. The storage medium may comprise a SW program which is configured to be executed on a processor and to thereby carry out the method described in this document.

In the context of the document, the term “automated driving” can be understood as meaning driving with automated longitudinal or lateral guidance or autonomous driving with automated longitudinal and lateral guidance. Automated driving can involve, for example, driving for a relatively long time on the freeway or driving for a limited time in the context of parking or maneuvering. The term “automated driving” comprises automated driving with any desired degree of automation. Exemplary degrees of automation are assisted, partially automated, highly automated or fully automated driving. These degrees of automation were defined by the BASt (Bundesanstalt für Straβenwesen-Federal Highway Research Institute) (see BASt publication “Forschung kompakt”, 11/2012 edition). During assisted driving, the driver permanently carries out the longitudinal or lateral guidance, while the system performs the respective other function within certain limits. During partially automated driving, the system performs the longitudinal and lateral guidance for a certain period and/or in specific situations, in which case the driver must permanently monitor the system, like during assisted driving. During highly automated driving, the system performs the longitudinal and lateral guidance for a certain period without the driver having to permanently monitor the system; however, the driver must be able to assume the vehicle guidance in a certain time. During fully automated driving, the system can automatically manage driving in all situations for a specific application; a driver is no longer required for this application. The four aforementioned degrees of automation correspond to SAE levels 1 to 4 of the standard SAE J3016 (SAE-Society of Automotive Engineering). For example, highly automated driving corresponds to level 3 of the standard SAE J3016. SAE level 5 is also provided in SAE J3016 as the highest degree of automation but is not included in the definition by the BASt. SAE level 5 corresponds to driverless driving, in which the system can automatically manage all situations like a human driver during the entire journey; a driver is generally no longer required.

It should be noted that the methods, devices and systems described in this document can be used both alone and in combination with other methods, devices and systems described in this document. Furthermore, any aspects of the methods, devices and systems described in this document can be combined with one another in various ways. In particular, the features of the claims can be combined with one another in various ways.

The invention is described in more detail below on the basis of exemplary embodiments. In the figures

### BRIEF DESCRIPTION OF THE DRAWINGS

FIG. 1 shows exemplary components of a vehicle;

FIG. 2a shows an exemplary user interface of a vehicle;

FIG. 2b shows an exemplary selection list of different driving functions; and

FIG. 3 shows a flowchart of an exemplary method for changing a driving function for the automated longitudinal guidance of a vehicle.

### DETAILED DESCRIPTION OF THE DRAWINGS

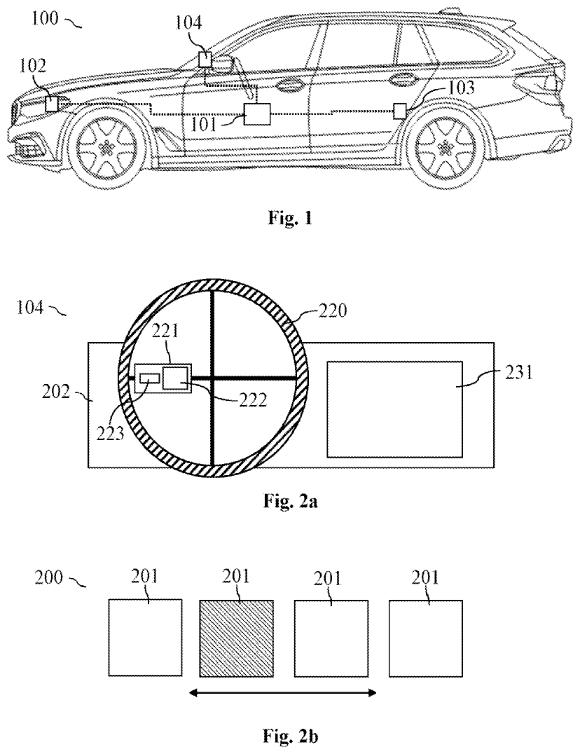

As set out at the beginning, the present document deals with the increase in comfort for the driver of a vehicle when selecting, in particular when changing, between different driving functions. In this context, FIG. 1 shows exemplary components of a vehicle 100. The vehicle 100 comprises one or more environmental sensors 102 (e.g., a radar sensor, a lidar sensor, a camera, an ultrasonic sensor, etc.) which are configured to capture environmental data (that is to say sensor data) relating to the environment of the vehicle 100. A (control) device 101 of the vehicle 100 is configured to operate one or more actuators 103 for the automated (longitudinal and/or lateral) guidance of the vehicle 100 on the basis of the environmental data in order to provide one or more driving functions. The one or more actuators 103 may comprise a drive motor of the vehicle 100 and/or one or more (friction) brakes of the vehicle 100.

An exemplary driving function is a distance and speed controller which is configured to automatically adapt the driving speed of the vehicle 100 on the basis of the distance between the vehicle 100 and a leading vehicle driving directly in front of the vehicle 100 and/or on the basis of a set speed that has been set. A further exemplary driving function is configured to take into account route incidents on the driving route used by the vehicle 100 in the longitudinal guidance of the vehicle. Exemplary route incidents are speed limits, bends, signaling installations (in particular traffic lights), etc.

The vehicle 100 comprises a user interface 104 (e.g., on the steering wheel and/or on the dashboard of the vehicle 100) which makes it possible for the driver of the vehicle 100 to make adjustments to the vehicle 100. In particular, it may be made possible for the driver to select a driving function for the automated longitudinal guidance of the vehicle 100 from a list of different driving functions for the automated longitudinal guidance in order to ensure that the vehicle 100 is operated using the selected driving function.

FIG. 2a shows an exemplary user interface 104 on a dashboard 202 of the vehicle 100. The user interface 104 may comprise one or more operating elements 221, for example, a selection operating element 223, for instance a rocker switch, which can be actuated by the driver of the vehicle 100 in order to scroll through a list of driving functions in order to select a driving function. As an alternative or in addition, the selection operating element 223 can be used to change, for example, to increase or decrease, and/or to set a parameter of a driving function (e.g., the set speed). Furthermore, the user interface 104 may optionally comprise a confirmation operating element 222 which can be used to confirm a selected driving function and/or a stipulated parameter. As an alternative, it may also be possible to automatically select a driving function and/or stipulate a parameter after a determined period of time (e.g., 2 seconds) has elapsed. The one or more operating elements 221 may be arranged on the steering wheel 220 of the vehicle 100.

The user interface 104 may furthermore comprise a screen 231 for outputting information, for example, for displaying the list of available driving functions and/or for displaying a parameter value which has been set. FIG. 2b shows an exemplary list 200 of different driving functions 201 which may be displayed on the screen 231. The driver of the vehicle 100 can scroll through the list 200 (as shown by the double-headed arrow) using an operating element 223 in order to select a particular driving function 201 from the list of driving functions 201. The selected driving function 201 is illustrated in FIG. 2b by a shaded area.

As already set out further above, the vehicle 100 may comprise a plurality of different driving functions 201 which support the driver of the vehicle 100 in the longitudinal guidance of the vehicle 100. These driving functions 201 can be provided to the driver via the selection list 200 for selection. Exemplary driving functions 201 include the following:
a distance and speed controller;
a speed controller with a set speed stipulated by the driver (as target specification for the controller);
a driving function 201 for identifying speed limits with automatic or manual adoption of the identified speed limit as set speed;
a speed limiter with a set speed stipulated by the driver (as maximum speed);
a driving function 201 with combined automated longitudinal guidance (e.g., by way of the distance and speed controller) and automated lane guidance; and/or
a driving function 201 for automatically taking into account route incidents (such as, for example, bends or signaling installations, in particular traffic lights).

The different driving functions 201 for the longitudinal guidance of the vehicle 100 typically each have a set speed which may be stipulated manually by the driver and/or which may be adopted automatically by the vehicle 100, for example, based on an identified speed limit. The (control) device 101 of the vehicle 100 may be configured, when the driving function 201 is changed by the driver, to adopt the set speed from the preceding driving function 201 as the set speed in the newly selected driving function 201. It is thus possible to increase comfort for the driver of the vehicle 100 because the set speed does not have to be stipulated again when the driving function is changed.

Automatic adoption of the set speed may be carried out as standard for a change between driving functions 201. The device 101 may also be configured to check whether an exceptional change between driving functions 201 has taken place, where automatic adoption of the set speed is prevented. To this end, the device 101 may be configured to check whether a change between driving functions 201 which has been carried out by the driver belongs to a predefined set of exceptional changes.

The set of exceptional changes may comprise as exceptional change a change from any desired driving function 201 to the speed limiter, in particular when the previously used set speed is lower than the current driving speed of the vehicle 100. In this case, the current driving speed of the vehicle 100 may be used (where appropriate automatically) as the new set speed for the speed limiter.

Another exemplary exceptional change includes a change from any desired driving function 201 to the speed controller, in particular when the previously used set speed is higher than the current driving speed of the vehicle 100. In this case, the current driving speed of the vehicle 100 may be used (where appropriate automatically) as the new set speed for the speed controller.

It is possible to further increase comfort for the driver of the vehicle 100 by taking into account a set of exceptional changes where, when the respectively active driving function 201 is changed, automatic adoption of the set speed is prevented (and where appropriate the current driving speed of the vehicle 100 is adopted automatically as the new set speed).

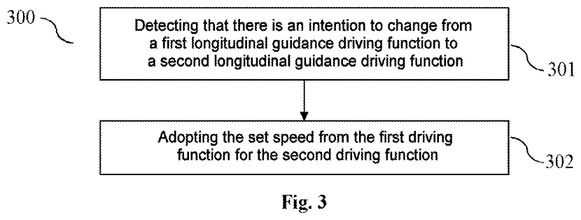

FIG. 3 shows a flowchart of an exemplary (possibly computer-implemented) method 300 for controlling the change between different driving functions 201 for the at least partially automated longitudinal guidance of a vehicle 100. The different driving functions 201 may in this case differ in terms of the extent to which the driving functions 201 each act on the longitudinal and/or lateral guidance of the vehicle 100.

The method 300 comprises detecting 301 that there is an intention to change from a first driving function 201 to a different second driving function 201. This may be identified, for example, on the basis of a user input via a user interface 104 of the vehicle 100.

The method 300 also comprises automatically adopting 302 the set speed for the at least partially automated longitudinal guidance from the first driving function 201 for the second driving function 201. In particular, it is possible in this case to avoid the user having to (again) input the set speed for the second driving function 201 via the user interface 104. Instead, it is possible to automatically operate the second driving function 201 at the set speed from the first driving function 201.

The measures described in this document make it possible to safely increase comfort when changing driving functions 201.

The present invention is not restricted to the exemplary embodiments shown. In particular, it should be noted that the description and the figures are intended to illustrate, only by way of example, the principle of the proposed methods, devices and systems.

1.-12. (canceled)

13. An apparatus for controlling a change between different driving functions for at least partially automated longitudinal guidance of a vehicle, wherein the apparatus is configured to:
detect that there is an intention to change from a first driving function to a different second driving function; and
automatically adopt a set speed for the at least partially automated longitudinal guidance from the first driving function for the second driving function.

14. The apparatus according to claim 13, wherein the apparatus is configured to:
check whether the change from the first driving function to the second driving function is an exceptional change from a set of one or more exceptional changes where the set speed is not intended to be adopted automatically for the second driving function; and
prevent the set speed from being adopted automatically when the change from the first driving function to the second driving function is the exceptional change; and/or
automatically adopt the set speed only when the change from the first driving function to the second driving function is not the exceptional change from the set of exceptional changes.

15. The apparatus according to claim 14, wherein the apparatus is configured to use a current driving speed of the vehicle as the set speed for the second driving function when the change from the first driving function to the second driving function is the exceptional change.

16. The apparatus according to claim 14, wherein the apparatus is configured to:
ascertain whether a current driving speed of the vehicle is lower than the set speed in a case in which the second driving function is a pure speed controller; and
consider the change from the first driving function to the second driving function as the exceptional change only when the current driving speed is lower than the set speed; and/or
prevent the set speed from being adopted automatically only when the current driving speed is lower than the set speed.

17. The apparatus according to claim 15, wherein the apparatus is configured to:
ascertain whether a current driving speed of the vehicle is lower than the set speed in a case in which the second driving function is a pure speed controller; and
consider the change from the first driving function to the second driving function as the exceptional change only when the current driving speed is lower than the set speed; and/or
prevent the set speed from being adopted automatically only when the current driving speed is lower than the set speed.

18. The apparatus according to claim 14, wherein the apparatus is configured to:
determine whether a current driving speed of the vehicle is higher than the set speed in a case in which the second driving function is a speed limiter; and
consider the change from the first driving function to the second driving function as the exceptional change only when the current driving speed is higher than the set driving speed; and/or
prevent the set speed being adopted automatically when the current driving speed is higher than the set speed.

19. The apparatus according to claim 15, wherein the apparatus is configured to:
determine whether a current driving speed of the vehicle is higher than the set speed in a case in which the second driving function is a speed limiter; and
consider the change from the first driving function to the second driving function as the exceptional change only when the current driving speed is higher than the set driving speed; and/or
prevent the set speed being adopted automatically when the current driving speed is higher than the set speed.

20. The apparatus according to claim 14, wherein the set of exceptional changes includes:
a change to a speed limiter as the second driving function; and/or
a change to a pure speed controller as the second driving function.

21. The apparatus according to claim 15, wherein the set of exceptional changes includes:
a change to a speed limiter as the second driving function; and/or
a change to a pure speed controller as the second driving function.

22. The apparatus according to claim 16, wherein the set of exceptional changes includes:
a change to a speed limiter as the second driving function; and/or
a change to a pure speed controller as the second driving function.

23. The apparatus according to claim 14, wherein
the first driving function and the second driving function are part of a set of possible driving functions; and
the set of possible driving functions includes:
a distance and speed controller;
a pure speed controller;
a speed limiter;
a distance and speed controller with combined lateral guidance;
a driving function for identifying and automatically or manually adopting a speed limit; and/or
a driving function for taking into account an upcoming route incident, in particular a bend or a signaling installation, in the longitudinal guidance of the vehicle.

24. The apparatus according to claim 15, wherein
the first driving function and the second driving function are part of a set of possible driving functions; and
the set of possible driving functions includes:
a distance and speed controller;
a pure speed controller;
a speed limiter;
a distance and speed controller with combined lateral guidance;
a driving function for identifying and automatically or manually adopting a speed limit; and/or
a driving function for taking into account an upcoming route incident, in particular a bend or a signaling installation, in the longitudinal guidance of the vehicle.

25. The apparatus according to claim 16, wherein
the first driving function and the second driving function are part of a set of possible driving functions; and
the set of possible driving functions includes:
a distance and speed controller;
a pure speed controller;
a speed limiter;
a distance and speed controller with combined lateral guidance;
a driving function for identifying and automatically or manually adopting a speed limit; and/or
a driving function for taking into account an upcoming route incident, in particular a bend or a signaling installation, in the longitudinal guidance of the vehicle.

26. The apparatus according claim 14, wherein
the vehicle comprises a user interface; and
the apparatus is configured to detect the change from the first driving function to the second driving function based on a user input via the user interface.

27. The apparatus according claim 15, wherein
the vehicle comprises a user interface; and
the apparatus is configured to detect the change from the first driving function to the second driving function based on a user input via the user interface.

28. The apparatus according claim 16, wherein
the vehicle comprises a user interface; and
the apparatus is configured to detect the change from the first driving function to the second driving function based on a user input via the user interface.

29. The apparatus according to claim 26, wherein the user interface allows a user of the vehicle to scroll through a list of possible driving functions by actuating an operating element in order to effect the user input for the change from the first driving function to the second driving function.

30. The apparatus according to claim 14, wherein
the set speed within the first driving function and/or the second driving function is used as a target specification for a speed controller for setting a driving speed of the vehicle; or
the set speed within the first driving function and/or the second driving function is used as a limit for the driving speed of the vehicle.

31. The apparatus according to claim 14, wherein the first driving function and the second driving function differ in relation to how the respective driving function acts on the longitudinal guidance of the vehicle.

32. A method for controlling a change between different driving functions for at least partially automated longitudinal guidance of a vehicle, the method comprising:
detecting that there is an intention to change from a first driving function to a different second driving function; and
automatically adopting a set speed for the at least partially automated longitudinal guidance from the first driving function for the second driving function.
